(19) United States
(12) Patent Application Publication
(10) Pub. No.: US 2023/0129415 A1
(43) Pub. Date: Apr. 27, 2023

(54) ANODE ACTIVE MATERIALS FOR LITHIUM-ION BATTERIES

(71) Applicant: WACKER CHEMIE AG, Munich (DE)

(72) Inventors: Jürgen Pfeiffer, Mehring (DE); Harald Hertlein, Burghausen (DE); Benedikt Köninger, Emskirchen (DE); Sebastian Liebischer, Mühldorf (DE)

(73) Assignee: Wacker Chemie AG, Munich (DE)

(21) Appl. No.: 17/800,505

(22) PCT Filed: Feb. 17, 2020
(86) PCT No.: PCT/EP2020/054078

§ 371 Date: Aug. 17, 2022

(51) Int. Cl. H01M 4/38; H01M 4/04; H01M 10/0525

(52) U.S. Cl. CPC H01M 4/386; H01M 4/0471; H01M 10/0525; H01M 2004/021

(57) ABSTRACT

An anode active material for use within an anode of a lithium-ion battery along with a method or process for preparing the same. Where the anode active material includes one or more non-aggregated silicon particles having BET surface areas of 0.2 to 10.0 m²/g (determination according to DIN 66131 (with nitrogen), a chloride content of 220 to 5000 ppm and a volume-weighted particle size distribution having diameter percentiles d₅₀ of 0.5 μm to 10.0 μm.

The invention relates to anode active materials containing silicon particles for lithium-ion batteries, to anodes containing anode active materials and to corresponding lithium-ion batteries.

Rechargeable lithium-ion batteries are today's practical electrochemical energy stores with the highest gravimetric energy densities. Silicon has a particularly high theoretical material capacity (4200 mAh/g) and is therefore particularly suitable as an active material for anodes in lithium-ion batteries.

Disadvantageously, silicon-containing anode active materials undergo extreme volume changes of up to approximately 300% when charging or discharging with lithium. This volume change causes severe mechanical stress on the anode active material and the entire anode structure which is also referred to as electrochemical milling and leads to a loss of electrical contact and destruction of the anode, thus resulting in a loss of capacity of the anode.

Furthermore, the surface of the silicon anode active material reacts with constituents of the electrolyte with continuous formation of passivating protective layers (Solid Electrolyte Interface; SEI). The components formed are no longer electrochemically active. The lithium bound therein is no longer available to the system, thus leading to a continuous loss of battery capacity. Due to the extreme volume change of the silicon during the charging and discharging operations of the battery, the SEI that has already formed regularly ruptures, thus exposing further surfaces of the silicon anode active material hich are then subjected to further SEI formation. Since the amount of mobile lithium in the cell as a whole is limited and is reduced in the course of SEI formation but the amount of mobile lithium corresponds to the usable capacity, the capacity of the cell decreases with the number of charging and discharging cycles of the battery. The decrease in capacity over the course of several charging and discharging cycles is also referred to as fading or continuous loss of capacity and is usually irreversible.

The use of silicon particles as anode active materials for lithium-ion batteries is described, for example, in WO2017/025346, WO2014/202529 and U.S. Pat. No. 7,141,334. To this end, EP1730800 teaches aggregated, nanoscale silicon particles whose primary particles have an average particle diameter of 5 to 200 nm. The anode coatings typically contain not only silicon but also other components, such as binders, graphite or conductive additives.

A number of industrial processes and process variants are known for the production of silicon as a starting material for anode active materials. In the metallurgical production of silicon, silicon dioxide is reacted with carbon. In alternative processes, silanes are converted into silicon by pyrolysis, for example using the Siemens, Komatsu-ASiMI or fluidized bed process. Both the Siemens and Komatsu ASiMI processes comprise deposition of silicon onto silicon rods while the fluidized bed process comprises deposition onto silicon particles. Monosilane (SiH₄) or chlorosilane are often used as silanes.

U.S. Pat. No. 8,734,991 recommends polycrystalline silicon particles having densities of 2.300 to 2.320 g/cm³ and crystallite diameters of 20 to 100 nm as anode active material for lithium-ion batteries. U.S. Pat. No. 8,734,991 lists a wide variety of processes for the production of silicon particles with a focus on monosilane (SiH₄) but without any indication of silane concentrations during during deposition of silicon or deposition rates.

To increase cycle stability of lithium-ion cells PCT/EP2018/076809 (application number) recommends non-aggregated silicon particles having a chloride content of 5 to 200 ppm and average particle size distributions d₅₀ of 0.5 to 10.0 μm as anode active material. Production of the silicon particles is mainly effected by deposition from trichlorosilane. Silane concentrations during the deposition of silicon or deposition rats are not reported.

WO2017058024 recommends Si/C composite anodes for lithium-ion batteries. Production of the silicon particles present in these composite anodes was effected by the Siemens process with trichlorosilane at deposition temperatures of 1150° C. or in a fluidized bed reactor with monosilane (SiH₄) or preferably after metallurgical production.

U.S. Pat. No. 9,099,717 discloses as anode active material polycrystalline silicon particles having a density of 2.250 to 2.330 g/cm³, a BET surface area of 0.1 to 5.0 m²/g, a compressive strength of 400 to 800 MPa and a crystallite diameter of 20 to 100 nm. Production of the silicon particles was carried out by evaporation of metallic silicon using electron beams and deposition of the resulting gaseous silicon on a substrate heated to 300° C. to 800° C. at reduced pressure.

DE102012207505 and DE3781223 are concerned with production of granular silicon for the photovoltaic or electronics, in particular semiconductor, industries. The granular silicon is obtained by pyrolysis of trichlorosilane on silicon seed crystals in fluidized bed reactors. Such granular silicons typically have particle sizes of 150 μm to 10,000 μm. The Siemens process is described, for example, in DE102007047210. The silicon rods obtained therewith are comminuted into chunks having dimensions of 1 to 150 mm.

EP2662334 is concerned with the optimization of processes for producing granular polysilicon for the semiconductor industry. The granular polysilicon has chlorine contents of 9 to 39 ppm and a particle size distribution of 150 μm to 10 000 μm. EP2662334 mentions lithium-ion batteries and solar cells as conceivable applications for the ultrafine particles produced as byproducts. Such ultrafine particles are visually perceived as brown in daylight and are known to have chlorine contents in the range from 15,000 to 20,000 ppmw as well as relatively high oxygen contents, large BET specific particle surface areas, very broad crystallite size distributions and very broad particle size distributions. The majority of the particles in such an ultrafine particle batch have particle diameters in the low nanometer range.

Against this backdrop there remains the object of providing anode-active materials which when used in lithium ion batteries allow a high cycle stability, wherein a low irreversible loss of capacity in the first cycle and a more stable electrochemical behavior with the lowest possible loss of capacity in subsequent cycles is to be achieved as far as possible.

The invention provides anode active materials for lithium-ion batteries, characterized in that the anode active materials comprise one or more non-aggregated silicon particles having a chloride content of 220 to 5000 ppm and a volume-weighted particle size distribution having diameter percentiles d₅₀ of 0.5 μm to 10.0 μm.

The non-aggregated silicon particles according to the invention are hereinbelow also referred to as silicon particles for short.

The silicon particles have a chloride content of preferably 250 to 4000 ppm, more preferably 280 to 3000 ppm, yet more preferably 600 to 2500 ppm, particularly preferably 750 to 2000 ppm and most preferably 1000 to 1900 ppm (method of determination: X-ray fluorescence analysis, preferably with Bruker AXS S8 Tiger 1 instrument, especially with rhodium anode). The ppm indications in the present specification preferably relate to ppmw.

It is preferable when 50% by weight, more preferably 75% by weight, particularly preferably 90% by weight and most preferably 99% by weight of the silicon particles based on the total weight of the silicon particles have a chloride content according to the invention.

The chloride is preferably not incorporated in the crystal lattice of silicon in the silicon particles. The chloride is preferably present in the silicon particles at the grain boundaries or crystallite boundaries of polycrystalline silicon. This may be determined by IR spectroscopy. The chloride is preferably incorporated in the silicon particles via covalent bonds, for example via chlorine-silicon bonds.

The silicon particles have volume-weighted particle size distributions having diameter percentiles d₅₀ of preferably 1.0 to 8.0 μm, more preferably 1.5 to 7.0 μm and most preferably 2.0 to 6.0 μm.

The volume-weighted particle size distribution of the silicon particles has diameter percentiles d₁₀ of preferably 0.2 μm to 10 μm, more preferably 0.5 μm to 5.0 μm and most preferably 0.8 μm to 3.0 μm.

The volume-weighted particle size distribution of the silicon particles has diameter percentiles d₉₀ of preferably 2.0 to 20.0 μm, particularly preferably 3.0 to 15.0 μm and most preferably 5.0 to 10.0 μm.

The volume-weighted particle size distribution of the silicon particles has a width d₉₀-d₁₀ of preferably ≤20.0 μm, more preferably ≤14.0 μm, most preferably ≤9.0 μm and most preferably of all ≤7.0 μm. The width d₉₀-d₁₀ is preferably ≥0.6 μm, particularly preferably ≥0.8 μm, most preferably ≥1.0 μm and most preferably of all ≥2.0 μm.

The volume-weighted particle size distribution of the silicon particles is determinable by static laser scattering, preferably using a Horiba LA 950 instrument with alcohols, for example ethanol or isopropanol, or preferably water as the dispersion medium for the silicon particles.

The silicon particles are preferably based on elemental silicon. Elemental silicon is to be understood as meaning preferably high-purity and/or polycrystalline silicon and/or a mixture of polycrystalline and amorphous silicon, optionally comprising a small proportion of foreign atoms (for example B, P, As).

The silicon particles preferably contain ≥95% by weight, more preferably ≥98% by weight, particularly preferably ≥99% by weight and most preferably ≥99.5% by weight of silicon. The indications in % by weight relate to the total weight of the silicon particles or the anode active material particles, especially to the total weight of the Silicon particles or the anode active material particles excluding their oxygen content. The inventive proportion of silicon in the silicon particles is determinable by ICP (inductively coupled plasma) emission spectrometry according to EN ISO 11885:2009 using the Optima 7300 DV instrument from Perkin Elmer.

The silicon particles generally contain silicon oxide. Silicon oxide is preferably to be found at the surface of the silicon particles. Silicon oxide may be formed for example in the production of the silicon particles by milling or during storage in air. Such oxide layers are also referred to as native oxide layers.

The silicon particles generally have on their surface an oxide layer, in particular a silicon oxide layer, having a thickness of preferably 0.5 to 30 nm, particularly preferably 1 to 10 nm and most preferably 1 to 5 nm (method of determination: for example HR-TEM (high-resolution transmission electron microscopy)).

The silicon particles preferably contain 0.1 to 5.0% by weight, more preferably 0.1 to 2% by weight, particularly preferably 0.1 to 1.5% by weight and most preferably 0.2 to 0.8% by weight of oxygen based on the total weight of the silicon particles (determined using Leco TCH-600 analyzer).

The silicon particles may be coated with carbon or be in the form of silicon-carbon composite particles. The silicon particles are preferably not coated with carbon. The silicon particles are preferably not in the form of silicon-carbon composite particles. There is preferably no carbon on the surface of the silicon particles.

The silicon particles are not aggregated, preferably also not agglomerated and/or preferably also not nanostructured.

Aggregated is be understood as meaning that spherical or very largely spherical primary particles, such as are initially formed in gas-phase processes in the production of silicon particles for example, have coalesced to form aggregates, for example are linked via covalent bonds. Primary particles or aggregates can form agglomerates. Agglomerates are a loose conglomeration of aggregates or primary particles. Agglomerates may easily be split back up into the primary particles or aggregates, for example using kneading or dispersing processes. Aggregates cannot or cannot practically be decomposed into the primary particles with these methods.

Aggregates and agglomerates generally have very different sphericities and particle shapes than the preferred silicon particles and are generally aspherical. The presence of silicon particles in the form of aggregates or agglomerates can be visualized for example using conventional scanning electron microscopy (SEM). By contrast, static light scattering methods for determining particle size distributions or particle diameters of silicon particles cannot distinguish aggregates and agglomerates.

The silicon particles preferably have sharp-edged fracture surfaces or are preferably shard-like.

The silicon particles have a sphericity of preferably 0.3≤ψ≤0.9, particularly preferably 0.5≤ψ≤0.85 and most preferably 0.65≤ψ≤0.85. Silicon particles having such sphericities are obtainable especially by milling processes. The sphericity ψ is the ratio of the surface area of a sphere of equal volume to the actual surface area of a body (definition by Wadell). In the case of a sphere, ψ is 1. Sphericities may be determined for example from conventional SEM micrographs.

The silicon particles have a circularity c in the range from preferably 0.4 to 0.9 and particularly preferably in the range from 0.5 to 0.8 based on the percentiles c₁₀ to c₉₀ of the circularity volume distributions. The circularity c is proportional to the ratio of the projection area A of a particle on a plane divided by the square of the corresponding circumference U of this projection: c=4π*A/U². In the case of a circular projection area c is 1. The measurement of circularity c is carried out for example with reference to micrographs of individual particles with an optical microscope or, in the case of particles <10 μm, preferably with a scanning electron microscope by graphical evaluation using image analysis software such as ImageJ.

Non-nanostructured silicon particles generally have characteristic BET surface areas. The BET surface areas of the silicon particles are preferably 0.2 to 10.0 m²/g, particularly preferably 0.5 to 8.0 m²/g and most preferably 1.0 to 5.0 m²/g (determination according to DIN 66131 (with nitrogen)).

The silicon particles are preferably polycrystalline. The silicon particles are preferably not monocrystalline. A polycrystal is generally a crystalline solid consisting of many small individual crystals (crystallites) separated from one another by grain boundaries. Amorphous material refers to a solid where the atoms do not form ordered structures but rather form an irregular pattern and exhibit only short-range order and not long-range order.

Polycrystalline silicon particles are characterized by crystallite sizes of preferably 200 nm, more preferably ≤100 nm, yet more preferably 60 nm, particularly preferably ≤20 nm, most preferably ≤18 nm and most preferably of all ≤16 nm. The crystallite size is preferably ≥3 nm, particularly preferably ≥6 nm and most preferably ≥9 nm. The crystallite size is determined by X-ray diffraction pattern analysis according to the Scherrer method from the full width at half maximum of the diffraction peak belonging to Si(111) at 2⊖=28.4°. The standard for the X-ray diffraction pattern of silicon is preferably the NIST X-ray diffraction standard reference material SRM640C (monocrystalline silicon).

The density of the silicon particles is in the range of preferably 2.250 to less than 2.330 g/cm³, particularly preferably 2.280 to 2.330 g/cm³, very particularly preferably 2.320 to 2.330 g/cm³ and most preferably 2.321 to 2.330 g/cm³. These values are generally lower than those of monocrystalline silicon. The density of the silicon particles is determinable by gas adsorption methods (pycnometer) with helium gas, preferably with a Pycnomatic ATC instrument from Porotec, in particular with a sample volume of 60 ml. The density of the silicon particles is preferably reported as an arithmetic average.

The silicon particles have a compressive strength of preferably 100 to 400 MPa, more preferably 130 to 360 MPa, particularly preferably 150 to 350 MPa and most preferably 200 to 300 MPa (determined with a microcompression tester from Shimadzu Corporation). The compressive strength of the silicon particles is preferably reported as an arithmetic average.

The silicon particles are preferably present in the form of particles having a gray appearance. The color of the silicon particles may be perceived as light gray to dark gray for example. The silicon particles are preferably not in the form of particles having a brown or brownish appearance. Determination of color is carried out visually in daylight and at 21° C. The shade of the silicon particles is preferably measured using the commercially available colorimeter NCS Color Scan 2 (light source: tridirectional LED lighting, 25 LEDs, 8×visible wavelength, 1× UV; device contains all 1950 NCS standard hues of edition 2). For example the measured result for gray colors is for example 4000-N which corresponds to 40% black, 60% white and 0% chromatic; gray colors generally contain no hue and are generally denoted only with a numerical value for the shade designation followed by an “—N” for neutral.

The silicon particles according to the invention are surprisingly and preferably obtainable by means of
1) pyrolysis of a reaction gas consisting of 11 to 19 mol % of silanes in a fluidized bed reactor at 600° C. to 910° C. to form granular silicon with the proviso that the silanes comprise dichlorosilane and/or monochlorosilane and subsequent
2) milling of the granular silicon from step 1) to form the silicon particles.

The invention further provides processes for producing anode active materials for lithium-ion batteries where
1) a reaction gas consisting to an extent of 11 to 19 mol % of silanes is subjected to a pyrolysis at 600° C. to 910° C. in a fluidized bed reactor to form granular silicon, with the proviso that the silanes comprise dichlorosilane and/or monochlorosilane, and subsquently
2) the granular silicon obtained in step 1) is milled to form silicon particles.

Step 1) is performed in a fluidized bed reactor, preferably in a radiantly heated fluidized bed reactor. The terms moving bed reactor and fluidized bed reactor are used interchangeably in the present technical field.

The term silanes generally refers to monochlorosilane, dichlorosilane, trichlorosilane, tetrachlorosilane and monosilane (SiH₄).

The reaction gas preferably comprises dichlorosilane and/or monochlorosilane and optionally monosilane (SiH₄). Dichlorosilane is particularly preferred.

The proportion of dichlorosilane among the silanes in the reaction gas is preferably 50 to 100% by weight, particularly preferably at least 90% by weight, yet more preferably at least 95% by weight and most preferably at least 99% by weight based on the total weight of the silanes.

The proportion of monochlorosilane among the silanes in the reaction gas is preferably 0% to 50% by weight, particularly preferably 0.1% to 10% by weight, yet more preferably 0.02% to 5% by weight and most preferably 0.5% to 1% weight based on the total weight of the silence. Alternatively, the reaction gas contains no monochlorosilane.

The proportion of monosilane (SiH₄) and/or trichlorosilane among the silanes in the reaction gas is preferably ≤10% by weight, particularly preferably ≤5% by weight and most preferably ≤1% by weight based on the total weight of the silanes. The reaction gas most preferably of all contains no monosilane (SiH₄). The reaction gas most preferably of all contains no trichlorosilane. The reaction gas most preferably of all contains no tetrachlorosilane.

Reaction gases that are most preferred comprise exclusively dichlorosilane and monochlorosilane as the silanes. Reaction gases that are most preferred of all comprise exclusively dichlorosilane as the silanes.

As further constituents the reaction gas may for example contain one or more inert gases or one or more reductive gases. Examples of inert gases are noble gases and in particular nitrogen. A preferred reductive gas is hydrogen.

The reaction gas introduced in step 1) contains 11 to 19 mol % and preferably 14 mol % to 19 mol % of silanes, wherein the silanes comprise dichlorosilane and/or monochlorosilane. The reaction gas introduced in step 1) particularly preferably contains 11 to 19 mol % and in particular 14 mol % to 19 mol % of dichlorosilane and/or monochlorosilane. The reaction gas introduced in step 1) most preferably contains 11 to 19 mol % and in particular 14 mol % to 19 mol % of dichlorosilane. The indications in mol % refer to the total molar composition of the reaction gas.

The remaining proportions of the reaction gas are preferably inert gases, in particular reductive gases.

The reaction gas most preferably consists of dichlorosilane and hydrogen.

The indications concerning the composition of the reaction gas in % by weight or in mol % preferably relate to the reaction gas introduced into the fluidized bed reactor relate, in particular to the composition of the reaction gas in the reaction gas nozzle. The indications in mol % preferably relate to the calculated average composition of all reactant gases introduced into the reactor. It is thus generally the reactant that is specified.

The pyrolysis or deposition of silicon takes is carried out in the fluidized bed reactor preferably at a temperature of 600° C. to 910° C., particularly preferably 700° C. to 860° C. and most preferably 720° C. to 830° C. These temperatures preferably occur in the fluidized bed of the fluidized bed reactor, especially in the reaction zone of the fluidized bed. Determining the temperature is described below under the heading “Determining the deposition temperature in the fluidized bed reactor”.

The pressure in the fluidized bed reactor is in the range of preferably 1.1 to 20 bara, particularly preferably 2 to 10 bara.

The height of the dumped bed in the fluidized bed reactor is preferably 50 to 1000 mm, more preferably 100 to 500 mm and most preferably in the range from 120 to 140 mm.

The deposition rate of silicon is preferably 0.17 to 0.57 μm/min, particularly preferably 0.20 to 0.38 μm/min and most preferably 0.23 to 0.35 μm/min. The deposition rate is known to specify the average growth in the diameter of a silicon particle per unit time during the deposition. Determining the deposition rate is described below under the heading “Determining the deposition rate G of silicon in the fluidized bed reactor”.

It is preferable when the granular silicon in step 1) of the process according to the invention is produced by deposition of a reaction gas on seed crystals of silicon, in particular silicon particles, in a fluidized bed.

The initially charged seed crystals in the fluidized bed are preferably fluidized using a silicon-free fluidizing gas, in particular hydrogen, and preferably heated by radiant heating. The thermal energy during heating is typically introduced uniformly over the circumference of the fluidized bed using flat radiant heaters. The reaction gas may be injected into the fluidized bed via one or more nozzles for example. Silane present in the reaction gas is generally deposited on the silicon particles as elemental silicon via a CVD reaction. Unreacted reaction gas, fluidization gas and gaseous secondary reaction products or by-products are generally removed from the reactor. The process may be operated as a continuous process by regular withdrawal of particles endowed with the deposited silicon from the fluidized bed and addition of seed crystals.

The process of step 1) is preferably operated continuously. The fluidized bed reactor is continuously supplied with seed crystals of milled silicon. It is preferable when granular silicon is continuously removed from the fluidized bed reactor. These measures also ensure that granular silicon of constant size is obtained.

The process for producing granular silicon by pyrolysis of reaction gas in a fluidized bed reactor may also be performed in a manner known per se, as described for example in DE102012207505.

The granular silicon obtained in step 1) has a particle size distribution in the range from 100 to 10 000 μm. Preference is given to 98% by mass in the range 600 to 4000 μm with a median value (d50.3) based on mass in the range from 1050 to 2600 μm (method of determination: dynamic image analysis according to ISO 13322-2, measured range 30 μm to 30 mm, dry measurement using powders/granular materials preferably with a Camsizer instrument from Retsch Technology).

The silicon particles obtained in step 1) have a sphericity of preferably 0.8≤ψ≤1.0, particularly preferably 0.9≤ψ≤1.0 and most preferably 0.91≤ψ≤1.0. The sphericity ψ is the ratio of the surface area of a sphere of equal volume to the actual surface area of a body (definition by Wadell). Sphericities may be determined for example from conventional SEM micrographs.

The silicon particles obtained in step 1) have a circularity c of preferably 0.8≤c≤1.0, particularly preferably 0.9≤c≤1.0 and most preferably 0.91≤c≤1.0. The circularity c is the ratio of the projection area A of a particle on a plane divided by the square of the corresponding circumference U of this projection: c=4π*A/U². Sphericities may be determined for example with image analysis from images of the particles, in particular with dynamic image analysis according to ISO 13322-2 preferably with a Camsizer instrument from Retsch Technology.

In step 2) the granular silicon from step 1) is milled to form the silicon particles according to the invention.

The milling may be carried out for example by wet milling or in particular by dry milling processes. Preferably employed mills include planetary ball mills, agitator ball mills or in particular jet mills, such as counter-jet or impact mills. Milling methods for these purposes are established per se. Thus, suitable dry milling processes are described for example in WO 2018/082789 or WO 2018/082794 and appropriate wet milling processes known from WO 2017/025346.

Milling generally results in non-aggregated silicon particles. By contrast, it is known that production of silicon particles with a particle size distribution according to the invention by exclusively gas-phase processes, such as gas-phase deposition, typically results in aggregated silicon particles.

The present invention further provides anodes, especially for lithium-ion batteries, containing anode active materials according to the invention.

The anodes preferably contain one or more binders, optionally graphite, optionally one or more for the electrically conductive components and optionally one or more additives, characterized in that one or more anode active materials according to the invention are present.

Examples of further electrically conductive components are conductivity black, carbon nanotubes, in particular single-layer or multi-layer carbon nanotubes, graphene or metallic particles, such as copper.

Preferred formulations for the anodes are based on preferably 5% to 95% by weight, in particular 60% to 85% by weight, of anode active materials according to the invention, in particular silicon particles according to the invention; 0% to 40% by weight, in particular 0% to 20% by weight, of further electrically conductive components; 0% to 80% by weight, in particular 5% to 30% by weight, of graphite; 0% to 25% by weight, in particular 5% to 15% by weight, of binder; and optionally 0% to 80% by weight, in particular 0.1% to 5% by weight, of additives; wherein the indications in % by weight relate to the total weight of the formulations and the proportions of all constituents of the formulations sum to 100% by weight.

The invention further provides a lithium-ion batteries comprising a cathode, an anode, a separator and an electrolyte, characterized in that the anode contains anode active materials according to the invention.

For clarity it is noted that the term lithium-ion battery also comprises cells. Cells generally comprise a cathode, an anode, a separator and an electrolyte. In addition to one or more cells lithium-ion batteries preferably also contain a battery management system. Battery management systems are generally used to control batteries, for example using electronic circuits, in particular for detecting the state of charge, for deep discharge protection or overcharge protection.

In a preferred embodiment of the lithium-ion batteries the anode material of the fully charged lithium-ion battery is only partially lithiated.

The present invention further provides processes for the charging of lithium-ion batteries comprising a cathode, an anode, a separator and an electrolyte, characterized in that the anode contains anode active materials according to the invention and the anode material is only partially lithiated during full charging the battery.

The present invention further provides for the use of the anode materials according to the invention in lithium-ion batteries which are configured in such a way that the anode materials are only partially lithiated in the fully charged state of the lithium-ion batteries.

In addition to the anode active materials according to the invention production of the electrode materials and lithium-ion batteries may employ the starting materials commonly used therefor and the processes for producing the electrode materials and lithium-ion batteries customary therefor, as described for example in WO 2015/117838 or the patent application having filing number DE 102015215415.7.

The lithium-ion batteries are preferably constructed/configured and/or preferably operated such that the material of the anode (anode material), in particular the anode active material, is only partially lithiated in the fully charged battery. Fully charged refers to the state of the battery in which the anode material of the battery, in particular the anode active material, exhibits its highest lithiation. Partial lithiation of the anode material is to be understood as meaning that the maximum lithium absorption capacity of the anode active material in the anode material is not exploited.

The ratio of the lithium atoms to the silicon atoms in the anode of a lithium-ion battery (Li/Si ratio) may be adjusted for example via the electric charge flow. The degree of lithiation of the anode material or of the silicon particles present in the anode material is proportional to the electrical charge that has flowed. In this. The capacity of the anode material for lithium is not fully utilized when charging the lithium-ion battery. This results in partial lithiation of the anode.

In an alternative, preferred variant the Li/Si ratio of a lithium-ion battery is adjusted via the anode to cathode ratio (cell balancing). The lithium-ion batteries are configured such that the lithium absorption capacity of the anode is preferably greater than the lithium emission capacity of the cathode. This has the result that the lithium absorption capacity of the anode is not fully exploited, i.e. the anode material is only partially lithiated, in the fully charged battery.

In the lithium-ion battery the ratio of the lithium capacity of the anode to the lithium capacity of the cathode (anode-to-cathode ratio) is preferably ≥1.15, particularly preferably ≥1.2 and most preferably ≥1.3. The term lithium capacity here preferably designates the usable lithium capacity. The usable lithium capacity is a measure of the capacity of an electrode to reversibly store lithium. The usable lithium capacity may be determined for example via half-cell measurements of the electrodes against lithium. The usable lithium capacity is determined in mAh. The usable lithium capacity generally corresponds to the measured delithiation capacity at a charging and discharging rate rate of C/2 in the voltage window of 0.8 V to 5 mV. C in C/2 refers to the theoretical, specific capacity of the electrode coating.

The anode is charged with preferably ≤1500 mAh/g, particularly preferably ≤1400 mAh/g and most preferably ≤1300 mAh/g based on the mass of the anode coating.

The anode is preferably charged with at least 600 mAh/g, particularly preferably ≥700 mAh/g and most preferably ≥800 mAh/g based on the mass of the anode coating. These indications preferably relate to the fully charged lithium-ion battery.

In the case of partial lithiation the Li/Si ratio in the anode material in the fully charged state of the lithium-ion battery is preferably ≤3.5, particularly preferably ≤3.1 and most preferably ≤2.6. The Li/Si ratio in the anode material in the fully charged state of the lithium-ion battery is preferably ≥0.22, particularly preferably ≥0.44 and most preferably ≥0.66.

The capacity of the silicon of the anode material of the lithium-ion battery is preferably utilized to an extent of ≤80%, particularly preferably to an extent of ≤70% and most preferably to an extent of ≤60% based on a capacity of 4200 mAh per gram of silicon.

The degree of lithiation of silicon or the utilization of the capacity of silicon for lithium (Si capacity utilization α) may be determined for example as described in the patent application having application number DE 102015215415.7 on page 11, line 4 to page 12, line 25, in particular using the formula recited there for the Si capacity utilization α and the additional indications under the headings “Determining the delithiation capacity β” and “Determining the Si weight fraction ωₛᵢ” (incorporated by reference).

It has surprisingly been found that silicon particles configured according to the invention as anode active materials allow lithium-ion batteries with particularly stable cycle behavior. These advantageous effects may be further enhanced by operating the lithium-ion batteries under partial lithiation.

The chloride contents according to the invention have proven particularly important. Silicon particles having higher or lower chloride contents as anode active materials resulted in lithium-ion batteries having lower cycle stability. Higher chloride contents can moreover result in unacceptable mechanical destruction of the silicon particles in the first charging cycle of a lithium-ion battery, thus leading to the formation of fresh silicon surfaces on which an SEI is in turn formed and so resulting in a further irreversible loss of lithium.

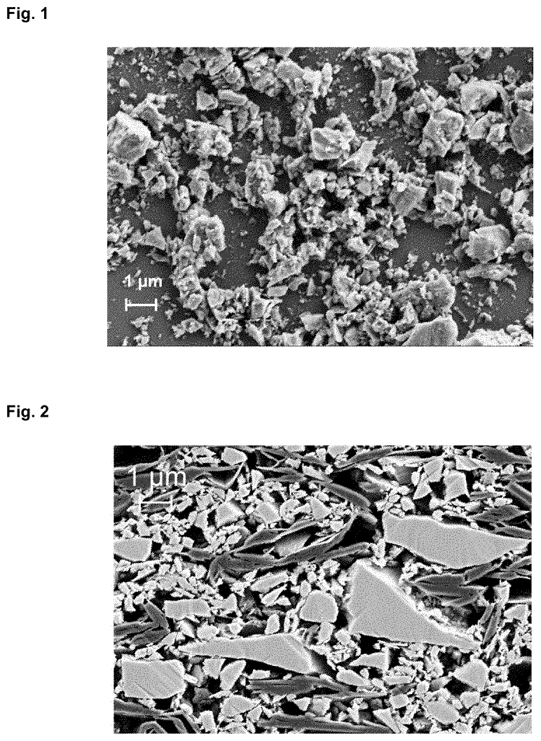

The process according to the invention, in particular the pyrolysis of silanes according to the invention under conditions according to the invention, has proven essential for producing the silicon particles according to the invention. By contrast, the fluidized bed process with trichlorosilane as the silane have proven unsuitable for producing silicon particles having a chloride content according to the invention. This was all the more surprising against the backdrop of U.S. Pat. No. 5,077,028 which is concerned with fluidized bed processes and teaches that the chloride content of silicon can be increased by reducing deposition rates, as is apparent for example from FIG. 1 of U.S. Pat. No. 5,077,028. However, U.S. Pat. No. 5,077,028 achieved silicon particles having chloride contents of at most 200 ppm using trichlorosilane and even chloride contents above 100 ppm are not obtainable economically in this way. However, the process according to the invention surprisingly made it possible to obtain silicon particles having inventive high chloride contents in economic fashion and, unexpectedly, precisely this made it possible to enhance the cycle stability of lithium-ion batteries.

By contrast, the Siemens process generally proved unsuitable for producing silicon particles having the chloride content according to the invention. The Komatsu-ASiMI process, which is performed using monosilane (SiH₄), cannot achieve chloride contents according to the invention. Fluidized bed processes with exclusively monosilane (SiH₄) naturally also do not result in the chloride contents according to the invention.

The examples which follow serve to further illustrate the invention:

Determining the Chloride Content of Silicon Particles:

Determination of the chloride content was carried out by X-ray fluorescence analysis on a Bruker AXS S8 Tiger 1 instrument with a rhodium anode. To this end, 5.00 g of the sample were mixed with 1.00 g of Boreox and 2 drops of ethanol and pressed into tablets for 15 seconds with a pressure of 150 kN in a HP 40 tablet press from Herzog.

Determining the Particle Sizes of Silicon Particles:

Measurement of the particle size distribution was performed by static laser scattering using the Mie model in a highly diluted suspension in ethanol with a Horiba LA 950 instrument. The particle size distributions determined are volume-weighted.

Determining the Density of Silicon Particles:

The density of the silicon particles was determined by gas adsorption methods (pycnometer) using the Pycnomatic ATC instrument from Porotec (helium gas, 60 ml sample volume).

Determining the Compressive Strength of Silicon Particles:

Determination of the compressive strength was carried out using an MCT Series 211 microcompression tester having the instrument designation DUH-211S with MCT-211E (trade name of Shimadzu Corporation).

Determining the Deposition Temperature in the Fluidized Bed Reactor:

Measurement of the temperature during deposition of silicon in the fluidized bed reactor was carried out with a thermocouple (type N thermocouple wire, 2×0.8 mm, according to DIN EN60584-1 with a measurement range up to 1200° C., ceramic insulation (external dimensions: 2.5×4.0 mm)). To protect against mechanical and chemical damage the thermocouple wire was surrounded by a protective tube made of a nickel-based alloy. The twisted measuring point at the upper end was mounted 230 mm above the bottom plate of the fluidized bed reactor. Any fluidized region of the fluidized bed below the reaction gas nozzles and at a distance of more than 20 mm from the reactor wall is in principle suitable for measurement of the deposition temperature

Determining the Deposition Rate G of Silicon in the Fluidized Bed Reactor:

The deposition rate G of silicon in the fluidized bed reactor is calculated according to the following formula:

G=\dot{W}/Sv*m,

\dot{W} is the deposition rate of silicon per unit time and results from the following mass balance:

\dot{W}=weight of the polysilicon withdrawn from the fluidized bed reactor (i.e. weight of the product), minus weight of the polysilicon added to the fluidized bed reactor (i.e. weight of the seed crystals).

Weight determination was carried out on a commercially available balance.

The measurements are carried out for specific units of time.

The unit of \dot{W} is [kg/min].

m is the weight of the silicon in the fluidized bed reactor during continuous operation.
The weight of silicon is constant during continuous operation of the fluidized bed reactor.

m has the unit [kg].

m is determined via the pressure drop dp, which is obtained by measuring the differential pressure between the bottom and the top of the fluidized bed reactor.

The pressure drop dp is proportional to the bed weight according to the formula dp*A=m*g;
dp is the differential pressure between the reactor bottom and reactor top (determined with the Deltabar FMD72 electronic differential pressure system from Endress+Hauser);
A is the cross-sectional area of the fluidized bed reactor (cross-sectional areas of any internals, such as nozzles, to be deducted);
g is 9.81 m/s².

Sv is the specific surface area of the silicon particles in the fluidized bed reactor during continuous operation. This surface area is constant during continuous operation of the fluidized bed reactor.

Sv is determined on the basis of the silicon particles obtained as product by means of image analysis using a particle analyzer (determination method: dynamic image analysis according to ISO 13322-2, measuring range with 30 μm to 30 mm, dry measurement using powders/granular material preferably with a Camsizer instrument from Retsch Technology).

Sv has the unit [1/μm].

### Example 1 (Ex.1): Production of Silicon Particles

A fluidized bed reactor is operated with a dichlorosilane mass flow of 2261 kg/h per m² of reactor cross-sectional area, a hydrogen flow of 2528 Nm³/h per m² of reactor cross-sectional area, a fluidized bed temperature of 775° C. and a reactor pressure of 3.0 barg.

The granular silicon obtained in this way was then comminuted by milling in a fluidized bed jet mill (Netzsch-Condux CGS16, with 90 m³/h of nitrogen at 7 bar as milling gas). The silicon particles obtained in this way had the following particle size distribution: d₁₀=2.4 μm, d₅₀=4.5 μm and d₉₀=7.2 μm.

The BET surface area of the silicon particles was 2.9 [m2/g], the density 2.326 [g/cm3] and the compressive strength 235 [MPa]. The SEM micrograph of the dry silicon particles in FIG. 1 shows that the silicon was in the form of individual non-aggregated, shard-like particles.

Further properties of the silicon particles are summarized in table 1.

### Example 2 (Ex.2): Production of Silicon Particles

Analogous to example 1 with the exceptions of altering the dichlorosilane amount to 1704 kg/h per m² of reactor cross-sectional area, the hydrogen flow to 2675 Nm³/h per m² of reactor cross-sectional area and the deposition temperature to 900° C. as reported in Table 1.

The granular silicon obtained in this way was subsequently comminuted by milling as in example 1.

The silicon particles obtained in this way had the following particle size distribution: d10=2.5 μm, d50=4.7 μm and d90=7.7 μm. The BET surface area of the silicon particles was 3.0 [m2/g], the density 2.322 [g/cm3] and the compressive strength 280 [MPa]. Further properties of the silicon particles obtained in this way are summarized in table 1.

### Comparative Example 3 (Comp. Ex. 3)

Production of Silicon Particles:

A fluidized bed reactor is operated with a trichlorosilane mass flow of 2269 kg/h per m² of reactor cross-sectional area, a hydrogen flow of 1433 Nm³/h per m² of reactor cross-sectional area, a fluidized bed temperature of 960° C. and a reactor pressure of 2.5 bar.

The granular silicon obtained in this way was then comminuted by milling in a fluidized bed jet mill (Netzsch-Condux CGS16, with 90 m³/h of nitrogen at 7 bar as milling gas). Further properties of the silicon particles are summarized in table 1.

### Comparative Example 4 (Comp. Ex. 4)

Production of Silicon Particles:

Analogous to Comparative example 3, with the exception that the deposition temperature was reduced to 785° C., as indicated in table 1.

The properties of the silicon particles obtained in this way are summarized in table 1. Reaction gas conversion, reactor yield and deposition rate were reduced by 50% compared to example 1 and therefore not economic.

### Comparative Example 5 (Comp. Ex. 5)

Production of Silicon Particles:

Analogous to example 1 with the exceptions of altering the dichlorosilane amount to 1230 kg/h per m² of reactor cross-sectional area, the hydrogen flow to 2770 Nm³/h per m² of reactor cross-sectional area and the deposition temperature to 960° C. as reported in Table 1.

The properties of the silicon particles obtained in this way are summarized in table 1.

### Comparative Example 6 (Comp. Ex. 6)

Production of Silicon Particles:

Analogous to example 1 with the exceptions of altering the dichlorosilane amount to 2890 kg/h per m² of reactor cross-sectional area, the hydrogen flow to 2400 Nm³/h per m² of reactor cross-sectional area and the deposition temperature to 960° C. as reported in Table 1.

The properties of the silicon particles obtained in this way are summarized in table 1.

### (Comparative) Examples 7 to 12 ((Comp.) Ex. 7-12)

Electrodes comprising silicon particles from examples 1 or 2 or comparative examples 3 to 6:

29.709 g of polyacrylic acid (Sigma-Aldrich, Mw ˜450,000 g/mol) dried to a constant weight at 85° C. and 751.60 g of deionized water were agitated for 2.5 h until complete dissolution of the polyacrylic acid using a shaker (290 rpm). Lithium hydroxide monohydrate (Sigma-Aldrich) was added portionwise to the solution until the pH was 7.0 (measured with WTW pH 340i pH meter and SenTix RJD probe). The solution was then mixed for a further 4 hours using the shaker.

7.00 g of the silicon particles of the respective (comparative) example 1 to 6 were dispersed in 12.50 g of the neutralized polyacrylic acid solution (concentration 4% by weight) and 5.10 g of deionized water using a dissolver at a circulation speed of 4.5 m/s for 5 min and of 12 m/s for 30 min with cooling at 20° C. After addition of 2.50 g of graphite (Imerys, KS6L C) the mixture was then stirred for a further 30 min at a circulation speed of 12 m/s. After degassing, the dispersion was applied to a copper foil having a thickness of 0.030 mm (Schlenk metal foils, SE-Cu58) using a film-drawing frame with a gap height of 0.10 mm (Erichsen, model 360).

The anode coating produced in this way was then dried at 80° C. and 1 bar of air pressure for 60 min.

The anode coating dried in this way had an average basis weight of 2.90 mg/cm² and a film thickness of 32 μm.

FIG. 2: SEM micrograph of FIB section of the electrode coating with the silicon particles from example 1 (silicon particles discernible by their light gray color).

### (Comparative) Examples 13 to 18 ((Comp.) Ex. 13-18)

Testing the electrodes from (comparative) examples 7-12: The electrochemical investigations were carried out on a button cell (type CR2032, Hohsen Corp.) in a 2-electrode arrangement. The electrode from the respective (comparative) example 7 to 12 was used as the counter electrode or negative electrode (Dm=15 mm) and a coating based on lithium-nickel-manganese-cobalt oxide 1:1:1 with a content of 94.0% and an average basis weight of 14.5 mg/cm² was used as the working electrode/positive electrode (Dm=15 mm). A glass fiber filter paper (Whatman, GD Type D) saturated with 120 μl of electrolyte was used as the separator (Dm=16 mm). The employed electrolyte consisted of a 1 molar solution of lithium hexafluorophosphate in a 3:7 (v/v) mixture of fluoroethylene carbonate and ethyl methyl carbonate admixed with 2% by weight of vinylene carbonate. The cell was constructed in a glove box (<1 ppm H₂O, O₂) and the water content in the dry matter of all components used was below 20 ppm.

The electrochemical testing was carried out at 20° C. The cell was charged by the cc/cv method (constant current/constant voltage) at a constant current of 5 mA/g (corresponds to C/25) in the first cycle and of 60 mA/g (corresponds to C/2) in the subsequent cycles and after reaching the voltage limit of 4.2 V at constant voltage until the current falls below a current of C/100 or C/8. The cell was discharged by the cc method (constant current) at a constant current of 5 mA/g (corresponds to C/25) in the first cycle and of 60 mA/g (corresponds to C/2) in the subsequent cycles until achieving the voltage limit of 3.0 V. The specific current chosen was based on the weight of the positive electrode coating.

As a result of the ratio of anode to cathode capacity resulting from the formulation the lithium-ion battery was operated with partial utilization of the anode at a Li/Si ratio of 1.1.

The results of the electrochemical testing are summarized in table 2.

### Comparative Example 19 (Comp. Ex. 19)

Production of silicon particles via the Siemens process:

A reaction gas consisting of 33 mol % of trichlorosilane in hydrogen was introduced into a bell-shaped reactor (“Siemens” reactor) into which slim rods had been introduced as the target substrate. At a temperature of 1070° C. silicon was deposited from a trichlorosilane stream of 108 kg/h/m² of slim rod surface and 36 Nm³ of H₂/h/m² of slim rod surface.

The silicon obtained in this way was initially subjected to manual pre-crushing and then pre-comminuted with roller crushers before it was subsequently comminuted to a size of d₅₀=4.6 μm by dry milling analogously to example 1.

The properties of the silicon particles obtained in this way are summarized in table 1.

### Comparative Example 20 (Comp. Ex. 20)

Production of silicon particles from monosilane using the FBR process:

In a fluidized bed reactor a monosilane mass flow of 81 kg/h per m² of reactor cross-sectional area, a hydrogen flow of 876 Nm³/h per m² of reactor cross-sectional area, a fluidized bed temperature of 640° C. and a reactor pressure of 2.5 bar were established.

The granular silicon obtained in this way was then comminuted by milling in a fluidized bed jet mill (Netzsch-Condux CGS16, with 90 m³/h of nitrogen at 7 bar as milling gas). The properties of the silicon particles obtained in this way are summarized in table 1.

As is apparent from table 1 the inventive silicon particles in examples 1 and 2 have a significantly higher chloride content, at 290 ppm and 1480 ppm respectively, than the products of comparative examples 3 to 5 and in particular comparative examples 19 and 20 whose chloride content is even below the detection limit located. By contrast, the silicon particles of comparative example 6 have a higher chloride content than the silicon particles of examples 1 and 2.

When employed as anode active material the silicon particles of the comparative examples result in lithium-ion batteries having a significantly lower cycling stability than the silicon particles of inventive examples 1 and 2, as shown in table 2.

TABLE 1
Reaction conditions during deposition of silicon
and properties of the silicon particles:

| | Deposition | | | Properties of Si particles | |
|---|---|---|---|---|---|
| | | Silane | | Cl | Particle size |
| (Comp.) | Temperature | content | G^{e)} | content | d₁₀/d₅₀/d₉₀ |
| Ex. | [° C.] | [mol %] | [μm/ min] | [ppm] | [μm] |
| 1^{a)} | 775 | 17 | 0.30 | 1480 | 2.4/4.5/7.2 |
| 2^{a)} | 900 | 12 | 0.28 | 290 | 2.5/4.7/7.7 |
| 3^{b)} | 960 | 21 | 0.16 | 23 | 2.4/4.5/7.2 |
| 4^{b)} | 785 | 21 | 0.08 | 102 | 2.5/4.7/7.7 |
| 5^{a)} | 960 | 9 | 0.16 | 39 | 2.5/4.6/7.5 |
| 6^{a)} | 960 | 21 | 0.57 | 6000 | 2.4/4.4/7.1 |
| 19^{c)} | 1070 | 33 | 30 | <3 | 2.4/4.6/7.6 |
| 20^{d)} | 640 | 6 | 0.15 | <3 | 2.6/4.8/7.9 |

Silane and reactor for deposition of silicon:
^{a)}Dichlorosilane, fluidized bed reactor;
^{b)}Trichlorosilane, fluidized bed reactor;
^{c)}Trichlorosilane, Siemens reactor;
^{d)}Monosilane, fluidized bed reactor.
^{e)}G: Deposition rate of silicon.

### Comparative Example 21 (Comp. Ex. 21)

Electrodes were produced analogously to example 7 with the exception that the silicon particles from comparative example 19 were employed instead of the silicon particles from example 1.

### Comparative Example 22 (Comp. Ex. 22)

Electrodes were produced analogously to example 7 with the exception that the silicon particles from comparative example 20 were employed instead of the silicon particles from example 1.

### Comparative Example 23 (Comp. Ex. 23)

The cell construction and the electrochemical testing were performed analogously to example 13 with the exception that electrodes from comparative example 21 were employed.

The electrochemical characteristics are summarized in table 2.

### Comparative Example 24 (Comp. Ex. 24)

The cell construction and the electrochemical testing were performed analogously to example 13 with the exception that electrodes from comparative example 22 were employed.

The electrochemical characteristics are summarized in table 2.

TABLE 2
Electrochemical testing of (comparative)
examples 13 to 18 and 23 to 24:

| | | Coulombic | Initial discharging | Cycle with |
|---|---|---|---|---|
| | Silicon | efficiency | capacity cycling | 80% |
| | particles | formation [%] | [mAh/cm²] | residual capacity |
| Ex. 13 | Ex. 1 | 81.4 | 2.12 | 386 |
| Ex. 14 | Ex. 2 | 81.6 | 2.15 | 374 |
| Comp. | Comp. | 81.5 | 2.09 | 312 |
| Ex. 15 | Ex. 3 | | | |
| Comp. | Comp. | 81.2 | 2.18 | 320 |
| Ex. 16 | Ex. 4 | | | |
| Comp. | Comp. | 81.6 | 2.07 | 291 |
| Ex. 17 | Ex. 5 | | | |
| Comp. | Comp. | 81.4 | 2.09 | 308 |
| Ex. 18 | Ex. 6 | | | |
| Comp. | Comp. | 81.7 | 2.10 | 246 |
| Ex. 23 | Ex. 19 | | | |
| Comp. | Comp. | 82.1 | 2.09 | 279 |
| Ex. 24 | Ex. 20 | | | |

The test results of table 2 show that the silicon particles of examples 1 and 2 result in lithium-ion batteries having markedly improved cycle stabilities compared to the low-chloride silicon particles of comparative examples 3 to 5, the high-chloride silicon particles of example 6 and the chloride-free silicon particles of comparative examples 19 and 20.

1-14.-(canceled)

15. An anode active material for lithium-ion batteries, comprising:
wherein the anode active material contains one or more non-aggregated silicon particles having BET surface areas of 0.2 to 10.0 m²/g (determination according to DIN 66131 (with nitrogen), a chloride content of 220 to 5000 ppm and a volume-weighted particle size distribution having diameter percentiles d₅₀ of 0.5 μm to 10.0 μm.

16. The anode active material of claim 15, wherein ≥50% by weight of the silicon particles based on the total weight of the silicon particles have a chloride content of 220 to 5000 ppm.

17. The anode active material of claim 15, wherein the silicon particles are polycrystalline and have crystallite sizes of <20 nm.

18. A process for producing anode active materials for lithium-ion batteries, comprising the steps of:
(1) providing a reaction gas consisting to an extent of 11 to 19 mol % of silanes is subjected to a pyrolysis at 600° C. to 910° C. in a fluidized bed reactor to form granular silicon, wherein the silanes comprise dichlorosilane and/or monochlorosilane, and subsequently; and
(2) obtaining the granular silicon from step (1) and milling it to form silicon particles.

19. The process of claim 18, wherein the proportion of dichlorosilane among the silanes in the reaction gas is 50% to 100% by weight based on the total weight of the silanes.

20. The process of claim 18, wherein the proportion of monosilane and/or trichlorosilane among the silanes in the reaction gas is ≤10% by weight based on the total weight of the silanes.

21. The process of claim 18, wherein the reaction gases contain exclusively dichlorosilane as the silanes.

22. The process of claim 18, wherein the reaction gas introduced in step (1) consists to an extent of 11 to 19 mol % of dichlorosilane.

23. The process of claim 18, wherein the reaction gas introduced in step (1) consists of dichlorosilane and hydrogen.

24. The process of claim 18, wherein an anode active materials is obtained.

25. An anode for lithium-ion batteries, comprising:
wherein said lithium-ion batteries comprises one or more anode active materials; and
wherein the anode active material contains one or more non-aggregated silicon particles having BET surface areas of 0.2 to 10.0 m²/g (determination according to DIN 66131 (with nitrogen), a chloride content of 220 to 5000 ppm and a volume-weighted particle size distribution having diameter percentiles d₅₀ of 0.5 μm to 10.0 μm.

26. A lithium-ion battery, comprising:
a cathode, an anode, a separator and an electrolyte;
wherein the anode contains one or more anode active materials; and
wherein the one or more active materials contain one or more non-aggregated silicon particles having BET surface areas of 0.2 to 10.0 m²/g (determination according to DIN 66131 (with nitrogen), a chloride content of 220 to 5000 ppm and a volume-weighted particle size distribution having diameter percentiles d₅₀ of 0.5 μm to 10.0 μm.

27. The lithium-ion battery of claim 26, wherein the anode is only partially lithiated in the fully charged lithium-ion battery.

28. The lithium-ion battery of claim 27, wherein in the fully charged state of the lithium-ion battery the ratio of the lithium atoms to the silicon atoms in the anode material is ≤3.5.
